(19) United States
(12) Patent Application Publication
(10) Pub. No.: US 2020/0194874 A1
(43) Pub. Date: Jun. 18, 2020

(54) LOOP RECTENNA

(71) Applicant: Drayson Technologies (Europe) Limited, London (GB)

(72) Inventors: Aline Coelho DE SOUSA, London (GB); Bruno Roberto FRANCISCATTO, London (GB); Vitor Andrade FREITAS, London (GB)

(21) Appl. No.: 16/608,440

(22) PCT Filed: Mar. 29, 2018
(86) PCT No.: PCT/GB2018/050873

§ 371 Date: Oct. 25, 2019

(30) Foreign Application Priority Data
Apr. 28, 2017 (GB) 1706874.3

(51) Int. Cl. H01Q 1/24; H01Q 7/00

(52) U.S. Cl. CPC H01Q 1/248; H01Q 1/245; H01Q 7/00

(57) ABSTRACT

An RF power harvester comprising a dielectric substrate, an antenna carried on the substrate for coupling with an RF electromagnetic field, the antenna comprising at least one track of conductive material arranged to provide at least one loop around an annular region at the edge of a first face of the substrate, wherein a signal collection gap in the loop provides an electrical connection for obtaining an RF signal from the antenna; and two signal links coupled to the gap and arranged to carry an electrical signal into a region on the substrate surrounded by the annular region.

### FIELD OF INVENTION

The present disclosure relates to methods and apparatus for harvesting energy from stray electromagnetic fields which may be emitted from electrical and electronic devices. The present disclosure also provides antennas designed to harvest power from such fields.

### BACKGROUND

The ability to transfer electrical energy over an air gap, or in vacuum, by means of alternating electromagnetic fields is well known. Two distinct applications have been developed for this phenomenon: wireless power transfer on the one hand, and wireless power harvesting on the other.

Wireless power transfer relies upon the deliberate transfer of power, either by inductive or capacitive coupling, from a dedicated transmitter to a dedicated receiver. Power harvesting relies upon stray electromagnetic fields, such as those generated by switching of electronic devices or by telecommunications transmitters, to harvest or scavenge power from their environment.

In the field of wireless power transfer systems to transfer electrical power using alternating electrical field (E-field) and/or alternating magnetic field (H-field). Some wireless power transfer systems operate using so-called near-field coupling. Although it is less common, others may use far-field coupling. Typically, H-field power transfer, also known as inductive power transfer may be more effective in the near-field, whereas in the far-field E-field effects may be more useful.

Wireless battery chargers and near-field RF communications devices both use inductive coupling to transfer power via an alternating H-field. Wireless battery chargers are in widespread use. Such chargers may include coils which operate, in effect, as the primary coil of a transformer, and couple inductively with a similar coil carried by the device which is to be charged. In these kinds of systems the transmitting and receiving coils can be placed in very close proximity to each other. Other types of wireless power transfer systems may operate in a similar way.

For example, near-field RF communications devices such as RFID and NFC devices are also in widespread use and are perhaps the most common type of wireless power transfer devices. The operating frequency of near field RF communications is around 13.56 MHz. The corresponding wavelength is about 22 meters. Accordingly, a half-wave dipole antenna would need to be about 11 meters in length if it were to radiate well. Generally, due to the circumstances in which they are most often used, NFC antenna area may be limited to about 7 cm×2.5 cm. The maximum linear dimension is thus about 0.5% of a wavelength—a consequence of this is that the radiation efficiency of an NFC antenna is generally very, very low. Generally therefore, the object of NFC antenna design is to occupy as large a volume as possible. Generally simple coils with multiple turns are used, and the frequency response of such inductors needs only to be specified very loosely. It barely needs to be considered at all.

Telecommunications antenna design on the other hand is a complex technical field which involves a variety of considerations. Telecommunications devices such as cellular telephone handsets, Wi-Fi® access points and routers, telecommunications network nodes such as base stations may provide relatively high energy emissions. These emissions can be used to mediate data signals over relatively long distances, and typically rely on far-field, as opposed to near-field, effects.

For wireless devices in general, and cellular telecommunications devices in particular, there is a general desire to increase communications range and to reduce energy losses in the environment immediately surrounding a wireless device. For example, cellular telephone handsets may be arranged to direct electromagnetic energy away from the body of a human user. This may assist in transmitting greater signal energy over greater distances.

### SUMMARY

The disclosure provides RF power harvesters adapted for use in miniaturised devices. Such RF power harvesters comprise an antenna for coupling with an RF electromagnetic field to provide an alternating electrical signal. The antenna is disposed on a dielectric substrate, which may be disc shaped.

For example, an aspect of the disclosure provides an RF power harvester comprising: a disc of dielectric substrate, an antenna carried on the substrate for coupling with an RF electromagnetic field, the antenna comprising at least one track of conductive material arranged to provide at least one loop around an annular region at the edge of a first face of the disc, wherein a signal collection gap in the loop provides an electrical connection for obtaining an RF signal from the antenna; and two signal links coupled to the gap and arranged to carry an electrical signal into a region on the substrate surrounded by the annular region.

The track of conductive material which provides the loop may be aligned with and follow the edge of the face of the disc (e.g. it may be parallel with the edge), thereby defining the annular region around the periphery of the disc.

More than one such loop may be provided around this annular region. The loop, or loops, may be ring shaped (for example they may be circular, oval, or polygonal). One or more gaps may be provided in the track(s) of conductive material to create a discontinuity in the track of conductive material. For example, in the aspect mentioned above, a signal collection gap is provided in the antenna loop to provide an electrical connection for obtaining an RF signal from the antenna.

As in the aspect outlined above, two signal links can be coupled to this gap, e.g. one signal link can be connected to the track end on one side of the gap, and a second signal link can be connected to the track end on the other side of the gap. This may provide a differential antenna.

Another aspect of the disclosure provides an RF power harvester comprising: a disc of dielectric substrate, an antenna carried on the substrate for coupling with an RF electromagnetic field, the antenna comprising a first track of conductive material arranged to provide a first loop, and a second track surrounded by the first loop, wherein the second track lies along a sector of the first track, and is spaced apart from it, and a first signal link is coupled to the first track, and a second signal link is coupled to the second track, and the signal links are arranged to carry an electrical signal into a region on the substrate that is surrounded by the two tracks.

Aspects of the disclosure which comprise two tracks may further comprise a third track surrounded by the track which defines the first loop and aligned with that first track. For example the two tracks may be parallel with each other. This third track may lie spaced apart from the first track, but only along a sector of the loop defined by the first track. The second and third tracks may lie along different sectors of that loop.

For example, the first loop may be closed, for example it may be circular. The second track may lie along a first sector of the first loop and the third track may lie along a second sector of the first loop. The spacing between the second track and the first sector may be equal to the spacing between the third track and the second sector. The second track and the third track may be semi-circular.

The first signal link may be connected to the second track, and the second signal link connected to the third track. The signal collection gap of these embodiments may be provided by a space between a first end of the second track and a first end of the third track.

A second end of the second track may be connected to the first track by a first bridge of conductive material, and a second end of the third track may be connected to the first track by a second bridge of conductive material.

The signal links of aspects of the disclosure may themselves be provided by lengths of conductive track. These tracks may be straight, and may be aligned with each other (e.g. they may be parallel with each other. To carry an RF electrical signal from the antenna and into a region on the substrate surrounded by the by the loop(s) of the antenna, the tracks may extend inwardly from the loop(s). As an example, the tracks which make up the signal links may be aligned with a diameter of loop(s). They may also be symmetric about the diameter. The signal links may be symmetric about a gap in the loop(s), or in an annular region defined by the loop(s). For example the spacing between the signal link tracks may be the same as the size (e.g. the width) of the break in the track which makes up the signal collection gap. This spacing between the signal links may be even along their length.

The length of the signal collection links, and the spacing between them, may be selected to provide impedance matching between the antenna and a rectifier disposed on the substrate. For example, the spacing between the links (and/or the size of the signal collection gap) may determine a capacitance. The length of the links may provide an inductance.

The substrate may be disposed in a cavity, which may have electrically conductive walls. The substrate may be arranged perpendicular to the walls of the cavity. The RF power harvester may be surrounded (e.g. around the edges of the substrate) by conductive walls, e.g. in the form of a casing such as a box or cylinder. The cross section of the casing may match the cross section of the substrate—for example in the case of a circular disc shaped substrate, the casing may be a cylinder. At least one of the end faces of the cavity may be covered by a non-conductive material, such as glass, or plastic. One of the end faces may be closed by a cap of conductive material, e.g. a metal. The cross section of the cavity may match the shape of the antenna loop. For example, the spacing between the outer edge of the antenna loop and the inside surface of the conductive wall may be even around the walls, for example it may be constant—e.g. the cavity may be a cylinder such as a circular cylinder.

### BRIEF DESCRIPTION OF DRAWINGS

Embodiments of the disclosure will now be described in detail with reference to the accompanying drawings, in which:

FIG. 1 shows a plan view of an RF power harvesting apparatus;

FIG. 2 shows a plan view of another RF power harvesting apparatus;

FIG. 3 shows a plan view of another RF power harvesting apparatus;

FIG. 4 shows a plan view of a rectifier; and

FIG. 5 shows a conductive cavity comprising an RF power harvesting apparatus.

In the drawings like reference numerals are used to indicate like elements.

### SPECIFIC DESCRIPTION

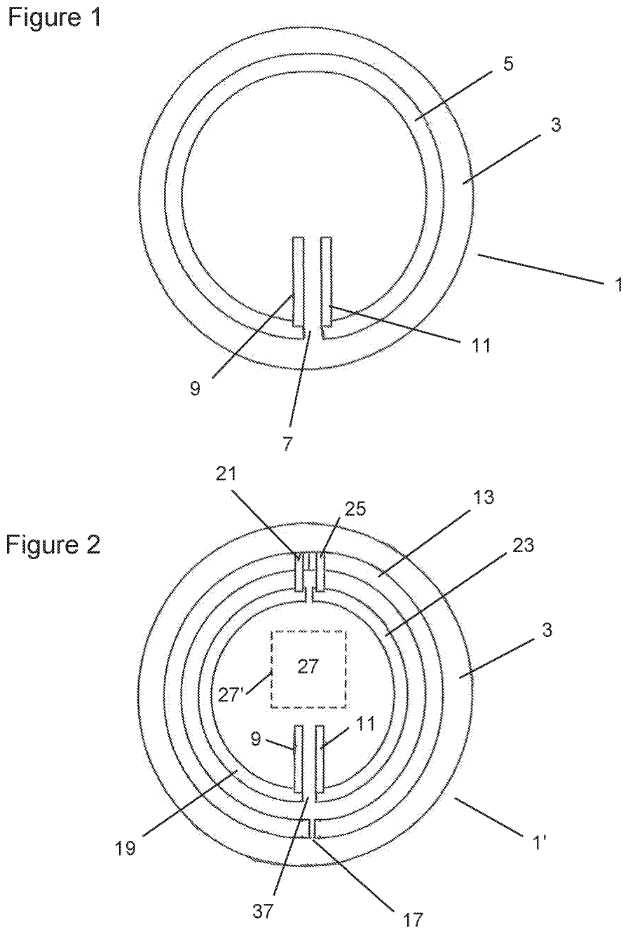

FIG. 1 shows a plan view of an RF power harvesting apparatus 1. The apparatus 1 comprises a dielectric substrate 3. The substrate 3 illustrated in FIG. 1 is flat and may be rigid, for example it may be of a circular disc shape.

Carried on the substrate 3 is a track of conductive material which is arranged in a circular loop 5. The loop 5 has a diameter of 32 mm, and the width of the track which makes up that loop is 1.5 mm.

There is a break 7 in the track at a location around the circumference of this loop 5, and at each side of this gap the track comes to an end. In other words—the ohmic/resistive conductive path provided by the loop is broken by the gap 7, e.g. it may present an open circuit to DC (direct current) voltages. It may however have a degree of capacitance, which can be selected by choosing the width of the gap (the distance of closest approach across the gap between the ends of the track).

One signal collection link 9, 11 is connected to each side of the gap in the track which makes up the loop 5. These links 9, 11 each comprise a straight length of conductive track and extend inward, toward the middle of the region that is bounded by the loop. These two links 9, 11 may be aligned with a diameter or (in the case of a non-circular loop) a line of symmetry of the loop which passes through the gap. For example, the two links 9, 11 may each be parallel with such a line, and spaced from it by the same distance. That line may bisect the gap 7 in the loop 5.

The signal collection links 9, 11 may also be connected to a rectifier (not shown in FIG. 1), which is carried on the substrate in the region bounded by the loop. The rectifier may in turn be connected to an energy store such as a battery or capacitor, and configured to charge the energy store with DC energy obtained from rectifying an alternating electrical signal provided by the antenna.

FIG. 2 illustrates a plan view of another RF power harvesting apparatus 1′. This apparatus 1′ also comprises a dielectric substrate 3, which may be of a circular disc shape, and this too may be flat and may be rigid.

A first track of conductive material is arranged on the substrate in a circular loop 13. This loop 13 has a diameter of 29 mm, and the width of the track which makes up that loop is 0.75 mm.

The loop 13 provided by the first track includes a gap 17, and at each side of this gap the track comes to an end to provide a break or discontinuity in the ohmic conduction path provided by the loop 13.

A second track 19 lies along the first track on the region of the substrate which is bounded by the loop 13. This track 19 lies along the inside edge of a sector of the loop 13, it may extend along about half of the loop in a curved path, which may be roughly semi-circular. One end of the second track terminates at the location of the first gap 17, and is connected to a first signal collection link 9 at that point. The other end of the second track 19 is connected, by a short length of conductive track 21, to the loop. This connecting bridge 21 may be opposite the first gap 17.

A third track 23 of conductive material is similarly arranged on the other side of the loop. The third track 23 lies along the inside edge of a different sector of the loop 13 provided by the first track. It lies inside the loop 13 and on the same surface of the substrate, but on the opposite side of the loop 13 from the second track. One end of the third track 23 terminates at the location of the first gap 17, on the other side of that gap 17 from the end of the second track. The third track 23 is connected to a second signal collection link 11 at that point. The other end of the third track 23 is connected, by a short length of conductive track 25, to the loop. This second connecting bridge 25 may be opposite the first gap. It will thus be appreciated that the third track 25, if it is spaced from the first track by the same distance as the second track 19, and is of the same length, may be symmetrical with the second track 19 about a line of symmetry which bisects the loop 13.

The two signal collection links 9, 11 may each comprise a straight length of conductive track and extend inward, toward the middle of the region 27 that is bounded by the loop. A gap 37 may be provided between the links 9, 11. These two links 9, 11 may be aligned with a line of symmetry of the loop 13 which passes through (e.g. bisects) the gap 7 in that loop. As explained above with reference to FIG. 1, the signal collection links may also be connected to a rectifier which may in turn be connected for charging an energy store with harvested power.

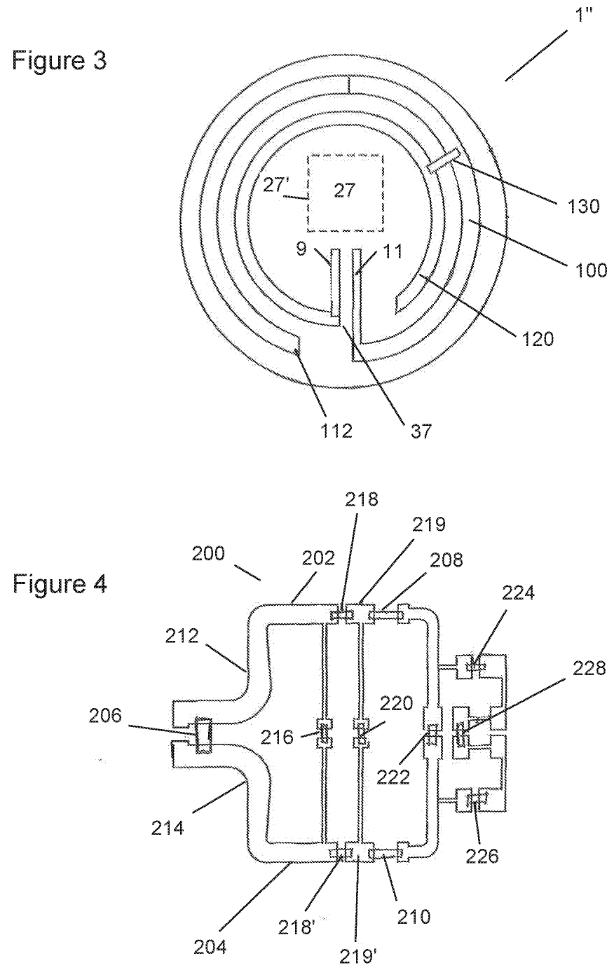

The conductive track structures described above, and the rectifier, may all be disposed on a first major surface of the substrate (e.g. on the same face of the disc). A layer of conductive material may be carried on the second major surface of the substrate, opposite to the first major surface (e.g. the other face of the disc). This layer may be disposed underneath the rectifier to provide a ground plane for that rectifier. The boundary of the region 27′ covered by this layer is illustrated in FIG. 2 using broken lines to indicate that it is not visible from that surface of the substrate. The signal collection links 9, 11 may extend into this region but on the first major surface of the substrate 3. This arrangement 27, 27′ may also be used in the apparatus 1 illustrated in FIG. 1 and FIG. 3.

FIG. 3 is a plan view of a third RF power harvesting apparatus 1″.

This apparatus also comprises a dielectric substrate 3, which may be flat and may be rigid, for example it may be a disc shape.

A first track 100 of conductive material is arranged on the substrate in an incomplete circular loop. A first end 110 of this first track is connected to a first signal link 11, and the first track 100 terminates at a second end 112 between 10° and 30° short of a complete circle (e.g. about 20° short).

A second track 120 lies along (e.g. parallel to) the first track 100 on the region of the substrate 3 which is bounded by the incomplete circular loop. A first end of this second track is connected to a second signal link 9, and the track 120 passes from this end, circumferentially around the inside of the first loop 100 to terminate at a second end between 10° and 30° short of a complete circle (e.g. about 20° short). The first signal link 11 passes through the space between the second signal link 9 and the second end of the second track 120. The second signal link 9 is on the same side of the first signal link 11 as the second end of the first track 120. A signal collection gap 37 is provided by the space between the two links 9, 11. It will thus be seen that, in the embodiment illustrated in FIG. 3, the second track is a left-right flipped version of the first track, and it follows a circular path of smaller diameter.

The first track 100 is connected to the second track 120 by a conductive bridge, which is arranged in a radial direction between the two tracks. This bridge 130 comprises a track of conductive material which may be perpendicular to the first track and the second track, but may also be arranged at some other selected angle. The bridge 130 and the signal collection gap 37 may be angularly separated along the circumference of the loop by an angle of between 90° and 180°, for example about 120°. As illustrated in FIG. 3, the signal collection gap between the two signal links is disposed at an angular position of about 180° (e.g. about 6 o'clock) whereas the bridge is disposed at an angular position of about 60° (e.g. about 2 o'clock).

The angular position of the bridge 130, the diameter of the loop provided by the first track 100, and the diameter of the loop provided by the second track 120, and the spacing between the two loops may be selected to tune the conductive track structure to provide an antenna for harvesting RF power at a particular RF frequency such as 900 MHz, and/or 2.4 GHz.

The conductive track structures described with reference to FIG. 3, and its rectifier, may all be disposed on a first major surface of the substrate 3 (e.g. on the same face of the disc). A layer of conductive material may be carried on the second major surface of the substrate, opposite to the first major surface (e.g. the other face of the disc). This layer may be disposed underneath the rectifier to provide a ground plane for that rectifier. The boundary of this region is illustrated in FIG. 2 using broken lines to indicate that it is not visible from that surface of the substrate. The signal collection links may extend into this region but on the first major surface of the substrate.

The two signal collection links 9, 11 may each comprise a straight length of conductive track and extend inward, toward the middle of the region that is bounded by the two incomplete circular tracks. These two links may be aligned with a line of symmetry which would, if those circle were complete, bisect them both and bisect the gap between the two signal links. The ends of these two signal collection links may also be connected to a rectifier for charging an energy store with harvested power.

The rectifier may be surrounded by the conductive tracks 5, 13, 23, 100, 120 which provide the antennas of the apparatus described herein. The rectifier however is not necessarily surrounded by the antenna. It could be inserted into the annular region of the antenna (e.g. inside the gap 7, 37 in the antenna loop, e.g. its feed point) or it may be adjacent to the antenna feed point 9, 11. It will also be appreciated in the context of the present disclosure that the antenna and rectifier could be assembled on different substrates, which may be stacked one on top of the other, e.g. in a multi-layered configuration and/or with antenna's and substrate's dielectric having different thickness and material, e.g. the antenna may be provided on a flexible substrate and rectifier on a rigid material.

FIG. 4 illustrates one example of a rectifier which may be connected to the signal collection links of any of the embodiments described herein.

The rectifier 200 comprises a first rectifying arm 202 and a second rectifying arm 204. These two arms 202, 204 each comprise an arrangement of conductive tracks. They may disposed on a dielectric substrate, such as the region 27′, which is circumscribed by an antenna structure, such as any one of those described above with reference to FIG. 1, FIG. 2, or FIG. 3.

The first rectifying arm 202 is connected to the second rectifying arm 204 by an inductor 206. This connection is provided near the input of the rectifier. It provides a DC conduction path to allow DC current to flow between the first rectifier arm and the second rectifier arm. The first rectifying arm 202 comprises a first rectifying element 208, and the second rectifying arm 204 comprises a second rectifying element 210. The rectifying elements 208, 210 may be provided by a one-way conduction path, e.g. a diode such as a Schottky diode. These rectifying elements 208, 210 may be arranged in opposition to each other to provide a differential rectifier.

The rectifying arms 202, 204 may each also comprise an impedance matching track 212, 214 in the form of a curve. This curve increases the spacing between the two rectifying arms 202, 204 across the surface of the substrate. A slight bulge or variation in track width may be provided along this curve. The shape and width of the bulge can be selected to provide a smooth (e.g. continuous) transition in impedance between the input of the rectifier and the rectifier proper (e.g. the rectifying elements). This impedance matching track connects the point at which the inductor 206 links the two arms to a point at which a further connection is provided between the first rectifying arm 202 and the second rectifying arm 204 by a first capacitor 216. The impedance matching track 212 of the first arm is connected to a first plate of this first capacitor 216, and the impedance matching track 214 of the second rectifying arm 204 is connected to the second plate of this first capacitor 216. The first plate of this first capacitor 216 is also connected to a short length 219 of conductive track by a first series inductor 218. This short length 219 of conductive track connects the first series inductor 218 to the first plate of a second capacitor 220, and to the input of the first rectifying element 208.

Similarly, in the second rectifying arm 204, the second plate of this first capacitor 216 is connected to a short length 219′ of conductive track by a second series inductor 218′. This short length 219′ of conductive track connects the second series inductor 218′ to a second plate of the second capacitor 220, and to the input of the second rectifying element 210.

The first capacitor 216, the second capacitor 218, the two series inductors 218, 218′, and the DC loop inductor 206 may each comprise lumped components—that is to say they may be provided by discrete components rather than by the inherent properties of transmission line structures.

The rectifying elements 208, 210 are arranged to generate, based on an RF voltage input, a DC signal and one or more harmonics of its RF voltage input. The rectifying elements are configured to output this DC signal and the one or more harmonics together with a component of its RF voltage input.

The output of the two rectifying elements is connected together by a third capacitor 222, and each of the two outputs are also connected, by an inductor 224, 226 to a corresponding one of two output couplings. These two output couplings can be connected together by a further capacitor 228, and may be coupled to charge an energy store as explained above.

This arrangement at the output of each rectifying element receives the DC signal from the rectifying element and the component of its RF voltage input and the one or more harmonics. The impedance transitions provided by the third capacitor and the inductor are chosen so as to reflect the one or more harmonics back towards the rectifier.

The first capacitor 216 and the second capacitor 218 and the series inductors 218, 218′ are arranged to guide an RF voltage input from the impedance matching track to the input of each rectifying element. This provides a signal coupling which reflects, back towards the rectifying element, radio frequency signals which have themselves been reflected, either by the rectifying element or by the arrangement at the output of each rectifying element.

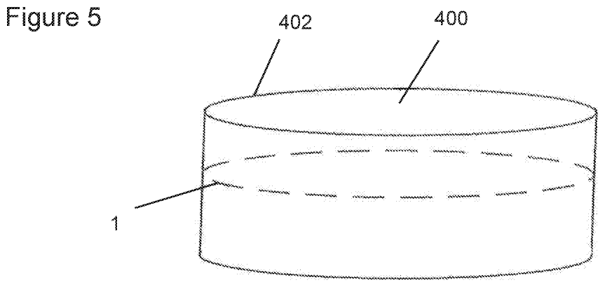

FIG. 5 illustrates an elevation view of an apparatus comprising a cavity 400 provided by a cylinder 402 of conductive material, and an RF power harvesting apparatus 1, 1′, 1″ such as any of those described herein. The cylinder 402 may provide a ground plane for this RF power harvesting apparatus, or a resonant cavity.

The position of the substrate 3 of such an RF power harvesting apparatus is indicated in FIG. 5 by broken lines. The cavity may have electrically conductive walls, which may have the internal form of a cylinder. The internal cross section of the cavity may match the shape of the antenna loop. The substrate may be arranged perpendicular to the walls of the cavity.

The substrates described herein are described as being circular, but they may also be other disc shapes such as oval or polygonal discs. They may have an irregular or asymmetric shape, chosen to fit them into a cavity such as that described with reference to FIG. 5. In some embodiments they need not be disc shaped.

The conductive material which makes up the tracks described herein may comprise or consist essentially of a metal such as copper, gold, or other highly and/or lightly conductive material as aluminium or stainless-steel composite material conductive material.

The tracks which provide the antenna loops and/or the signal links and/or bridges each have a selected width (e.g. lateral extent across the substrate). The tracks also have a selected thickness (extent normal to the plane of the substrate 9), which may be constant across their width—e.g the tracks may be rectangular in cross section. Depending on their thickness, and perhaps the depth to which they might extend into the substrate the tracks may at least partially stand proud from the surface of the substrate. The tracks may be deposited on to the substrate, for example by a subtractive technique, e.g. by providing a layer of the conductive material on to the substrate and then selectively etching it away to create the tracks. Alternatively the tracks could be laid down by an additive technique, for example by deposition of the conductive material in a pattern that provides the conductive tracks. However they are provided onto the substrate, typically the tracks conform to the surface of the substrate and are mechanically supported by it.

The thickness of either or both of the tracks may be even around the loops so the top surface of the tracks is flat, or at least follows the shape of the underlying substrate. It will be appreciated in the context of the present disclosure that by varying the width and/or thickness of the tracks their impedance can be adjusted. Such variations may be applied to the loop(s) as a whole, and/or to some selected parts of the loop(s).

The substrate may comprise an electrical insulator such as a dielectric laminate material, which may comprise a thermoset plastic. This may be a 0.5 mm thick FR4 board, but other substrates may be used. Such substrates may have a loss tangent of between 0.02 and 0.05 at the frequency bands of the antenna. These frequency bands may comprise the 2.4 GHz WiFi band (spanning 2.4 GHz to 2.495 GHz) and the 900 MHz GSM band. The substrate may have a loss tangent of between 0.003 and 0.004 at these frequencies, for example 0.0035. The substrate may have a relative permittivity of between 2.17 to 10.2, for example between 3 and 6, for example about 5, for example 4.8. The substrate may be rigid. For example it may have a Young's modulus of at least 1 GPa, for example at least 5 GPa, for example at least 10 GPa, for example less than 40 GPa, for example less than 25 GPa. The substrate may have a young's modulus of between 10 GPa and 30 GPa, for example between 20 GPa and 25 GPa. One example of such a material is FR-4 glass epoxy.

It will, of course, be appreciated that this example of a material is given by way of example only, and that other substrate materials (e.g. R04003® produced by Rogers Corp™ which has a relative permittivity of 3.55 and a loss tangent of 0.0027 at these frequencies, or a R03000® series high-frequency laminate) may be used.

The substrate may be at least 100 μm thick, for example between 100 μm and 3 mm, for example between 0.125 mm and 1.52 mm. In an embodiment the substrate is rigid and is 0.75 mm thick.

The antenna may be manufactured by subtractive or additive processes as described above. It may also be manufactured by assembling pre-manufactured components together such as by adhering a conductive sheetlike element to the substrate. This may be done by laying down a preformed track of the conductive material, or by laying down a larger sheet and then etching it away. This sheetlike element may be grown or deposited as a layer on the substrate. If it is deposited a mask may be used so the deposition happens only on regions which are to carry the conductive track and/or it may be allowed to take place over a larger area and then selectively etched away. Other methods of manufacture may also be used. For example, the antenna may be manufactured by way of ‘3D printing’ whereby a three-dimensional model of the antenna is supplied, in machine readable form, to a ‘3D printer’ adapted to manufacture the antenna. This may be by additive means such as extrusion deposition, Electron Beam Freeform Fabrication (EBF), granular materials binding, lamination, photopolymerization, or stereolithography or a combination thereof. The machine readable model comprises a spatial map of the object to be printed, typically in the form of a Cartesian coordinate system defining the object's surfaces. This spatial map may comprise a computer file which may be provided in any one of a number of file conventions. One example of a file convention is a STL (STereoLithography) file which may be in the form of ASCII (American Standard Code for Information Interchange) or binary and specifies areas by way of triangulated surfaces with defined normals and vertices. An alternative file format is AMF (Additive Manufacturing File) which provides the facility to specify the material and texture of each surface as well as allowing for curved triangulated surfaces. The mapping of the antenna may then be converted into instructions to be executed by 3D printer according to the printing method being used. This may comprise splitting the model into slices (for example, each slice corresponding to an x-y plane, with successive layers building the z dimension) and encoding each slice into a series of instructions. The instructions sent to the 3D printer may comprise Numerical Control (NC) or Computer NC (CNC) instructions, preferably in the form of G-code (also called RS-274), which comprises a series of instructions regarding how the 3D printer should act. The instructions vary depending on the type of 3D printer being used, but in the example of a moving printhead the instructions include: how the printhead should move, when/where to deposit material, the type of material to be deposited, and the flow rate of the deposited material. In some embodiments the power harvesting antenna may be encapsulated in a flexible case, for example a polycarbonate case.

The tracks may be deposited or printed and other components, such as the rectifier mentioned above, may also be provided by the same process.

The antenna as described herein may be embodied in one such machine readable model, for example a machine readable map or instructions, for example to enable a physical representation of said antenna to be produced by 3D printing. This may be in the form of a software code mapping of the antenna and/or instructions to be supplied to a 3D printer (for example numerical code).

The above embodiments are to be understood as illustrative examples. Further embodiments are envisaged.

Where the operation of apparatus has been described, it will be appreciated that this is intended also as a disclosure of that operation as a method in its own right, which may be implemented using other apparatus. Likewise, the methods provided herein, and individual features of those methods may be implemented in suitably configured hardware. The configuration of the specific hardware described herein may be employed in methods implemented using other hardware.

With reference to the drawings, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

Any feature described in relation to any one embodiment may be used alone, or in combination with other features described, and may also be used in combination with one or more features of any other of the embodiments, or any combination of any other of the embodiments. And, those features may be generalised, removed or replaced as will be appreciated in view of the present disclosure and as set out in the claims. Furthermore, equivalents and modifications not described above may also be employed without departing from the scope of the invention, which is defined in the accompanying claims.

1. An RF power harvester comprising:
a dielectric substrate,
an antenna carried on the substrate for coupling with an RF electromagnetic field, the antenna comprising at least one track of conductive material arranged to provide at least one loop around an annular region at the edge of a first face of the substrate, wherein
a signal collection gap in the loop provides an electrical connection for obtaining an RF signal from the antenna; and
two signal links coupled to the gap and arranged to carry an electrical signal into a region on the substrate surrounded by the annular region.

2. The apparatus of claim 1 wherein the signal links are aligned with a diameter of the annular region.

3. The apparatus of claim 2, wherein the signal links are symmetric about the gap.

4. The apparatus of claim 2 or 3, wherein the signal links are symmetric about the diameter.

5. The apparatus of any preceding claim wherein the at least one track comprises a first track arranged to provide a first loop, and a second track surrounded by the first loop.

6. The apparatus of claim 5, wherein the second track is parallel to the first track.

7. The apparatus of claim 5 or 6 wherein the second track lies along, and spaced apart from, a sector of the first track.

8. The apparatus of claim 6 or 7, wherein the at least one track comprises a third track surrounded by the first loop and parallel to the first track.

9. The apparatus of claim 8 wherein the third track lies along, and spaced apart from, a sector of the first track.

10. The apparatus of any of claims 5 to 9 wherein the first loop is closed.

11. The apparatus of any of claims 5 to 10, wherein the first loop is circular.

12. The apparatus of claim 10 or 11, wherein the gap is provided by a space between a first end of the second track and a first end of the third track.

13. The apparatus of claim 12 wherein a first one of the signal links is connected to the second track, and a second one of the signal links is connected to the third track.

14. The apparatus of claim 12 or 13, wherein:
a second end of the second track is connected to the first track by a first bridge of conductive material; and
a second end of the third track is connected to the first track by a second bridge of conductive material.

15. The apparatus of claim 5, 6 or 7 wherein a first one of the signal links is connected to a first end of the first track, and a second one of the signal links is connected to a first end of the second track.

16. The apparatus of claim 15, wherein a second end of the second track is spaced from the first signal link by a spacing at least as large as the gap between the first track and the second track.

17. The apparatus of claim 15, wherein a second end of the first track is spaced from the second signal link by a spacing at least as large as the gap between the first track and the second track.

18. The apparatus of claim 15, 16, or 17, wherein the first track is connected to the second track by a conductive bridge.

19. The apparatus of claim 18 wherein the bridge comprises a track of conductive material which is perpendicular to the first track and the second track.

20. The apparatus of claim 18 or 19 wherein the bridge is spaced from the second end of the second track by a distance selected to tune the antenna.

21. The apparatus of claim 20 wherein the antenna is tuned to one of: (i) 900 MHz; and (ii) 2.4 GHz.

22. The apparatus of any preceding claim further comprising a rectifier that is coupled to the antenna by the signal links.

23. The apparatus of claim 22 wherein the annular region surrounds the rectifier.

24. The apparatus of claim 23 wherein the rectifier is carried on the same face of the substrate as the antenna.

25. The apparatus of claim 23 or 24 wherein the substrate carries a ground plane on the opposite face of the substrate from the rectifier.

26. The apparatus of claim 25 wherein the ground plane is surrounded by the annular region of the disc.

27. The apparatus of any of claims 22 to 26, wherein the rectifier comprises:
a first rectifying arm for generating a DC signal based on a first RF voltage input obtained from the first signal link, and
a second rectifying arm for generating a DC signal based on a second RF voltage input obtained from the second signal link,
wherein,
the first rectifying arm is connected to the second rectifying arm by a connection which comprises a DC loop inductor to allow DC current to flow between the first rectifier arm and the second rectifier arm.

28. The apparatus of claim 26 wherein a further connection is provided between the first rectifying arm and the second rectifying arm by a first capacitor.

29. The apparatus of claim 27 wherein the first capacitor and the DC loop inductor comprise lumped components.

30. The apparatus of claim 28 wherein the rectifying arms each comprise an impedance matching track arranged to provide a transition in impedance at an input to the rectifier, and the first capacitor and the DC loop inductor are connected by the impedance matching track.

31. The apparatus of claim 30 wherein the impedance matching tracks also serve to increase the separation across the face of the dielectric between the first rectifying arm and the second rectifying arm.

32. The apparatus of any of claims 27 to 31 wherein each rectifying arm comprises a rectifying element arranged to generate, based on its RF voltage input, the DC signal and one or more harmonics of its RF voltage input, and to output the DC signal and the one or more harmonics together with a component of its RF voltage input;
a first signal coupling arranged to guide its RF voltage input to the rectifying element; and
a second signal coupling arranged to receive from the rectifier the DC signal, the component of its RF voltage input and the one or more harmonics from the rectifying element, and to reflect the one or more harmonics back towards the rectifying element;
wherein the first signal coupling is further arranged to reflect back towards the rectifier radio frequency signals from the rectifying element that are based on the reflected signals.

33. The apparatus of claim 32 wherein the first signal coupling comprises a series inductor connected between the DC loop inductor and the rectifying element.

34. The apparatus of claim 33 wherein the series inductor is provided by a lumped component.

35. The apparatus of claim 33 or 34 wherein the two rectifier arms are connected together by a second capacitor at the connection between the series inductor and the rectifying element of each arm.
